(19) United States
(12) Patent Application Publication
(10) Pub. No.: US 2008/0252477 A1
(43) Pub. Date: Oct. 16, 2008

(54) METHOD AND APPARATUS FOR AUTHENTICATING USE OF A BATTERY IN A WIRELESS COMMUNICATION DEVICE

(75) Inventor: JASON N. HOWARD, ALPHARETTA, GA (US)

Correspondence Address: MOTOROLA INC, 600 NORTH US HIGHWAY 45, W4 - 39Q, LIBERTYVILLE, IL, 60048-5343, US

(73) Assignee: MOTOROLA, INC., LIBERTYVILLE, IL (US)

(21) Appl. No.: 11/735,623

(22) Filed: Apr. 16, 2007

(51) Int. Cl. G08B 23/00

(52) U.S. Cl. 340/693.1

(57) ABSTRACT

A method for communicating authenticity of a battery in a wireless communication device. The wireless communication device executes an authentication process to determine the authenticity of the battery used in the wireless communication device. The wireless communication device establishes a communication link with a wireless network. The wireless communication device notifies a network server if the battery is not authenticated while allowing the portable communication device to function. The network server performs a specific task in response to a notification received.

### FIELD OF THE INVENTION

The present invention relates generally to a battery of a wireless communication device and, more specifically, to a method and apparatus for authenticating use of a battery in a wireless communication device.

### BACKGROUND OF THE INVENTION

The use of wireless communication devices is popular, because they are light weight and compact. It is not unusual for a consumer to own and utilize a multitude of such devices, examples of such devices including cellular telephones, Personal Digital Assistants (PDAs), hand-held computers and the like. The wireless communication devices are typically equipped with one or more rechargeable batteries or battery packs. Many mobile phone manufacturers design their phones to operate with proprietary batteries that may have a unique pin layout and size.

Unfortunately, the high cost of proprietary batteries has created a demand for aftermarket batteries which are not authentic. Aftermarket batteries may be manufactured by unauthorized suppliers and may not be produced with the same quality control as those manufactured by authorized suppliers. Furthermore, an unauthentic battery may not provide sufficient power in comparison to authentic batteries and may discharge in a relatively short period of time. As a result, a customer who unknowingly buys the unauthentic battery may be dissatisfied with the quality of the wireless communication device and may believe the quality defect is from the wireless communication device manufacturer, rather than from the unauthentic battery supplier.

In addition, an unauthentic aftermarket battery may not meet the safety standards as an authentic battery. As a result, the unauthentic batteries may pose a significant safety risk to the wireless device user. The Consumer Product Safety Commission reports cases of unauthentic batteries either exploding or catching fire thereby creating a potential hazard to users. This may result in bad publicity and possible legal issues against the manufacturer of the wireless communication devices and/or the service provider.

Approaches have been suggested to detect the usage of unauthentic batteries in the wireless communication devices. According to US 2006/0178170 A1, wireless communication device has an authentication apparatus and method to determine whether an authorized supplier manufactured the battery. The above mentioned reference discloses that the wireless communication device provides information regarding an unauthentic battery to a network server and thereafter powers down. As such, the apparatus and method of US 2006/0178170 A1 penalizes users and a wireless network provider, and may violate certain government regulations, by preventing devices from functioning, even if the use of the unauthenticated battery occurred through no fault of their own.

Accordingly, there is a need for an improved method and apparatus for reporting unauthenticated batteries to a network server while allowing the wireless communication device to function.

### BRIEF DESCRIPTION OF THE DRAWINGS

FIG. 1 is a system view of a preferred embodiment in accordance with the present invention.

FIG. 2 is a block diagram illustrating exemplary components of the wireless communication devices of FIG. 1.

FIG. 3 is flow diagram illustrating an operation of one wireless communication device of FIG. 1.

### DETAILED DESCRIPTION OF THE EMBODIMENTS

A method and apparatus for authenticating a battery used in a wireless communication device includes an authentication circuit capable of checking authenticity of the battery. In particular, a reader coupled to the wireless communication device reads authenticity details stored in a memory of the battery.

For one embodiment, the wireless communication device establishes a connection with a wireless network, and when the authenticity details are not authorized the wireless communication device sends a notification message to a network server. Wireless communication devices communicate through network infrastructure and utilize wireless communication protocols such as AMPS, CDMA, TDMA, GSM, iDEN, GPRS, EDGE, UMTS, WCDMA, CDMA2000, and their variants.

One aspect of the present invention is a method for communicating authenticity of a battery used in a wireless communication device. The wireless communication device executes an authentication process to determine the authenticity of the battery used in the wireless communication device. The wireless communication device establishes a communication link with a wireless network. The wireless communication device notifies a network server if the battery is not authenticated while allowing the portable communication device to function. The network server performs a specific task in response to a notification received.

Another aspect of the present invention is a wireless communication device comprising a battery, an authentication circuit and a transceiver. The battery has a memory configured to store authenticity details. The authenticating circuit is configured to check authenticity of the battery. The transceiver is configured to transmit a first notification message to a network server in the event of the wireless communication device not authenticating the battery. The wireless communication device continues to function regardless of the authenticity of the battery.

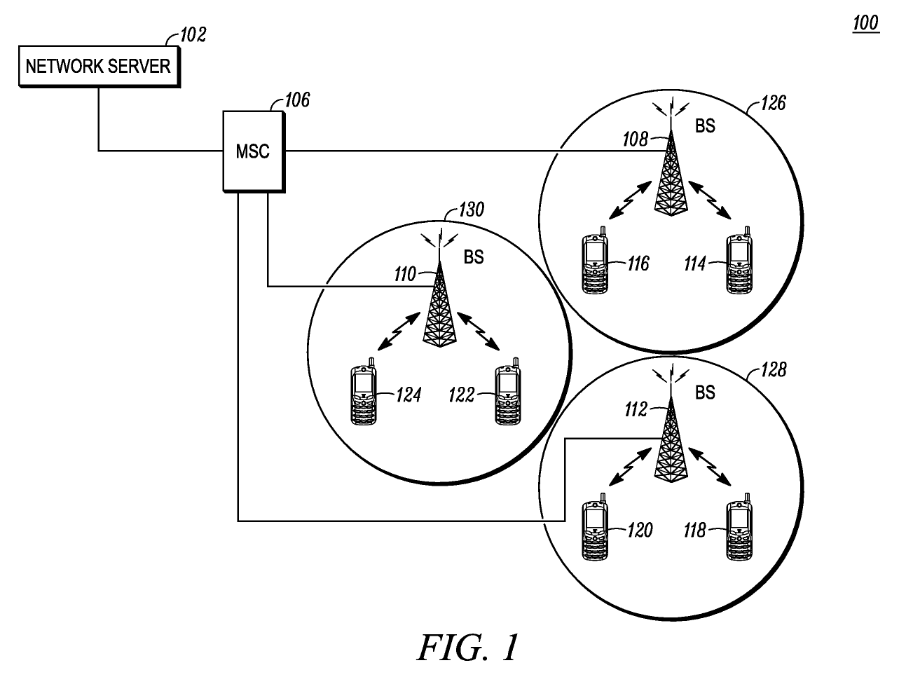

Turning now to the drawings where like numerals represent like components, FIG. 1 is a system diagram illustrating a wireless communication system 100 including wireless communication devices 114, 116, 118, 120, 122, 124, base stations 108, 110, 112, one or more Mobile Switching Center (MSC) 106, a network server 102 and a plurality of cells 126, 128, 130. In one embodiment of the present invention, the wireless communication system 100 provides battery authentication in at least one of the wireless communication devices 114, 116, 118, 120, 122, 124. Each of the plurality of cells 126, 128, 130 includes at least one base station. In the illustrated embodiment, cell 126 includes the base station 108 and wireless communication devices 114, 116. Cell 128 includes the base station 112 and wireless devices 118,120. Similarly, cell 130 includes the base station 110 and wireless devices 122, 124.

Each wireless communication device 114, 116, 118, 120, 122, 124 includes the capability to communicate with the base station 108, 110, 112 of their respective cells through wireless communication protocols such as AMPS, CDMA, TDMA, GSM, iDEN, GPRS, EDGE, UMTS, WCDMA, CDMA2000, and their variants. Each wireless communication device 114, 116, 118, 120, 122, 124 may also use ad-hoc communication to connect directly to each other and execute applications that may utilize the ad-hoc connection. For one embodiment, the wireless communication device 114 is capable of communicating with the wireless communication device 116 through an ad-hoc network such as Bluetooth, Infrared, 802.11a and the like.

The wireless communication devices 114, 116, 118, 120, 122, 124 may be any suitable wireless communication devices, including cell phones, personal digital assistants (PDAs), hand-held computers, Bluetooth headsets, and the like. The wireless communication devices 114, 116, 118, 120, 122, 124 may have any type of form factor. Examples of such form factor include clam/flip, candy bar, slider, keyboard, rotator, touch screen and other form factors commonly known in the industry.

Further, it should be understood that the present invention is not limited to mobile wireless communication devices. Other types of wireless access terminals which may include fixed wireless terminals may be used. For a better understanding, only wireless communication devices are shown and discussed hereafter. However, it should be understood that the term “wireless communication device” in the claims and description below includes both truly wireless communication devices (e.g., mobile phones, wireless handheld computers), stationary wireless terminals (e.g., fixed wireless router) or other electronic battery operated devices coupled to a network.

In the illustrated embodiment, cells 126, 128, 130 are shown approximately circular for a better understanding of the invention. However it should be noted that, in a typical cellular wireless communication network, true cells are irregular in shape and with different configurations. The shape and configuration of a cell depends on various features such as terrain, natural obstructions, man made obstructions and the like.

For a better understanding, only one base station is described in each cell. However, one or more base stations may be present in each of the plurality of cells 126, 128, 130.

Base stations 108, 110, 112 transfer voice and data signals among each other via wireless and/or wired communications link. For example, base stations 108, 110, 112 establish communication link between each of the wireless communication device 114, 116, 118, 120, 122, 124. Base stations 108, 110, 112 may also transfer data packets through GPRS or Internet to the wireless communication devices 114, 116, 118, 120, 122, 124.

In one embodiment of the present invention, the base stations 108, 110, 112 communicate with the MSC 106. For illustrative purposes, only one MSC 106 is shown, however it should be understood that one or more MSCs may be utilized by the base stations 108, 110, 112. In one embodiment of the present invention, MSC 106 collects data from the base stations 108, 110, 112 and forwards the collected data to the network server 102. The collected data may include battery information, user id, device id, and other related parameters of the wireless communication device 114, 116, 118, 120, 122, 124. The collected data may also include information related to the wireless communication protocols used by the wireless communication device 114, 116, 118, 120, 122, 124.

In another embodiment of the present invention, the base stations 108, 110, 112 comprise one or more base station controller and one or more base transceiver station. For a better understanding, the base station controller and the base transceiver station are collectively shown as base stations 108, 110, 112.

Operationally in the illustrated embodiment, the wireless communication device 114 powers on and checks whether the battery used is a replaced battery or not. After detecting the replaced battery the wireless communication device 114 runs an authentication process to check the authenticity of the battery. This authentication process may include reading authenticity details stored in a memory of the battery. In one embodiment of the present invention the authenticity details in the memory may be encrypted and the authentication process may also include a de-encryption process. In one embodiment of the present invention, if the battery is not authenticated, a notification message is sent to the base station 108. Base station 108 relays that message to the MSC 106, whereby MSC 106 further notifies the network server 102 that the battery used in the wireless communication device 114 is not authenticated.

For one embodiment of the present invention, wireless communication devices 114, 116, 118, 120, 122, 124, communicate with each other using ad-hoc connection, as mentioned above. For example, the wireless communication device 114 may send a notification message which includes authenticity details of a battery used in wireless communication device 114 to wireless communication device 116.

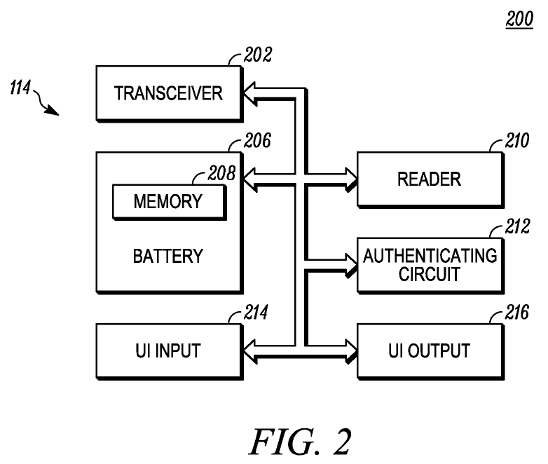

Referring to FIG. 2, there is provided a block diagram illustrating exemplary internal components 200 of the wireless communication device, such as device 114 shown in FIG. 1. For a better understanding of the present invention exemplary internal components of the wireless communication device 114 are described hereafter. However, it should be understood that the internal components 200 may be for the wireless communication devices 116, 118, 120, 122, 124. The wireless communication device 114 includes one or more transceiver 202, and a battery 206 including a memory 208, a reader 210, an authenticating circuit 212, one or more input devices 214 and one or more output devices 216. Alternatively, the authenticating circuit 212 may be in the battery 206 rather than the wireless communication device. Each wireless communication device may include a user interface that comprises one or more output devices 216 and one or more input devices 214. The transceiver 202 may utilize wireless technology such as the aforementioned wireless communication protocols. The battery 206 supplies power to the internal components. The memory 208 may include authenticity details of the battery 206. The authenticity details may include information related to a battery manufacturer, date of manufacturing, battery identification (“ID”) or other details related to the battery 206. As mentioned above, the authenticity details in the memory 208 may be encrypted and then de-encrypted by the authenticating circuit 212.

The reader 210 is configured for reading authenticity details which are stored in the memory 208 of the battery 206. The authenticating circuit 212 is configured for checking the authenticity details of the battery 206 and determining whether the battery is authentic or not.

The input and output devices 214, 216 of the internal components 200 may include a variety of video, audio and/or mechanical outputs. For example, the output device(s) 214 may include a video output device such as a liquid crystal display and light emitting diode indicator, an audio output device such as a speaker, alarm and/or buzzer, and/or a mechanical output device such as a vibrating mechanism. Likewise, by example, the input devices may include a video input device such as an optical sensor (for example, a camera), an audio input device such as a microphone, and a mechanical input device such as a flip sensor, keyboard, keypad, selection button, touch pad, touch screen, capacitive sensor, motion sensor, and switch. Actions that may actuate one or more input devices 214 include, but are not limited to, opening the wireless communication device, unlocking the device, moving the device to actuate a motion, moving the device to actuate a location positioning system, and operating the device.

Operationally, the reader 210 may check whether the battery 206 is a replaced battery or not. When the battery 206 used in the wireless communication device 114 is a replaced battery, the authenticating circuit 212 runs an authentication process to check the authenticity of the battery 206. When the battery 206 fails to get authenticated, the transceiver 202 sends a first notification message to the network server 102. The first notification sent to the network server 102 may include information related to a user ID associated with the wireless communication device 114. The first notification message may also include a time and a date at which the authentication process is executed on the wireless communication device 114.

The network server 102 after receiving the notification message may perform a specific task. The specific task performed by the network server 102 may be of maintaining a database of the notifications received regarding unauthenticated batteries. For example, the network server may use the database to settle warranty claims against manufacturers of the wireless communication device 114. The database may also be used to create future laws on use of unauthenticated batteries. The database may also be used to promote design changes to prevent use of unauthentic batteries.

In one embodiment of the present invention, the transceiver 202 is configured to receive a second notification message from the network server 102. The second notification message may be a mail to an official ID of a user of the wireless communication device 114 or a mail to the wireless communication device 114. The second notification message may also be a phone call to the wireless communication device 114 or an alert on a display of the wireless communication device 114. In one embodiment of the present invention, the phone call to the wireless communication device may be done by an automated system warning the user of the wireless communication device about any issues that may occur due to use of an unauthenticated battery.

In one embodiment of the present invention, the wireless communication device 114 continues to function while it sends the first notification message to the network server 102 and receives the second notification message from the network server 102. The wireless communication device 114 will not power down or lock any feature when the battery 206 is not authenticated. In another aspect, the user operates the wireless communication device 114 normally regardless of the authenticity of the battery 206.

It is to be understood that FIG. 2 is for illustrative purposes only and is for illustrating components of a wireless communication device, such as devices 114, 116, 118, 120, 122, 124, in accordance with the present invention, and is not intended to be a complete schematic diagram of the various components required for the wireless communication device. Therefore, the wireless communication device may include various other components not shown in FIG. 2 and still be within the scope of the present invention.

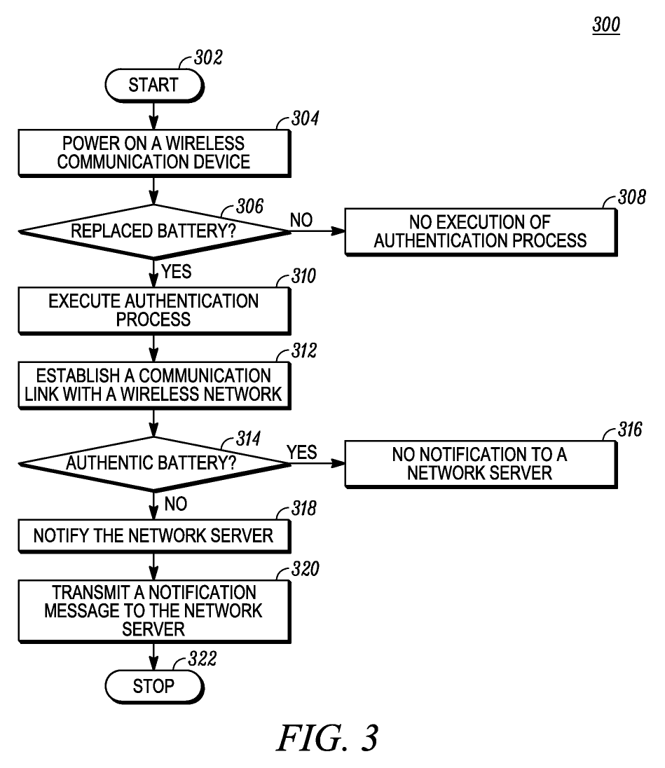

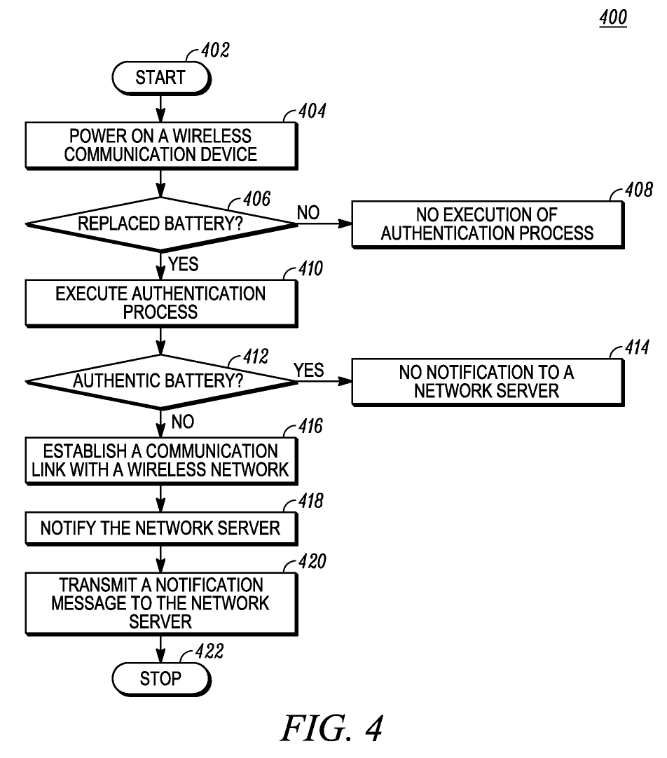

Referring to FIG. 3, there is shown an operation 300 of a wireless communication device, such as device 114 shown in FIG. 1 for communicating authenticity of a battery to a network server. However, it should be understood that the operation 300 may be performed by the wireless communication devices 116, 118, 120, 122, 124 also. The operation 300 initiates at step 302, and then the wireless communication device 114 powers ON at step 304. Powering ON may be initiated by a user interface of the wireless communication device 114, such as an input device 214. For example, a user of the wireless communication device 114 may manipulate one or more keypad buttons to power ON. The wireless communication device 114 after powering ON detects whether a replaced battery is used or not at step 306. For example, the user of the wireless communication device 114 may replace original battery with an aftermarket battery. In another example, the user of the wireless communication device 114 may replace SIM card causing the same battery to be pulled out and replaced back in.

In one embodiment of the present invention, upon detecting that the battery 206 (as disclosed in FIG. 2) is a replaced battery, an authentication process is executed at step 310. For example, the authentication process may be executed by the authenticating circuit 212. The authentication process may also employ the reader 210 (as disclosed in FIG. 2) to read authenticity details stored in the memory 208 of the battery 206. If the battery 206 is not a replaced battery, no authentication process is executed at step 308 and the wireless communication device 114 functions normally.

After step 310, the wireless communication device 114 then establishes a communication link with a wireless network at step 312. The wireless network may provide various services to the wireless communication device 114, which include service to receive an incoming call, make an outgoing call, establish a GPRS connection and other wireless applications. In the illustrated embodiment of the present invention, the wireless network includes the network server 102. The network server 102 may receive request messages from the wireless communication device 114 for activation of certain additional facilities and/or features. The network server 102 may also maintain a database of the requests received and also notifications, if any sent by the wireless communication device 114. In one aspect of the present invention, a communication link with the network server 102 may be established using the aforementioned wireless communication protocols.

After establishing the communication link with the wireless network as described above, the wireless communication device 114 then checks whether the replaced battery is an authentic battery or not at step 314. In one embodiment of the present invention, the reader 210 after reading the authenticity details of the battery 206 may forward the authenticity details to the authenticating circuit 212. For example, the authenticity details may include information related to a battery manufacturer, a date at which the battery 206 was manufactured, a geographical zone where the battery 206 was manufactured, a serial number of the battery 206 and other information related to the battery 206. The authenticating circuit 212 collects the authenticity details and checks for the authenticity of the battery 206. The authenticating circuit 212 then decides whether the battery 206 is an authentic battery or not.

If the replaced battery used with the wireless communication device 114 is not an authentic battery, the network server 102 is notified at step 318 and a notification message is sent by the wireless communication device 114 at step 320. In one embodiment of the present invention, the notification message sent to the network server 102 may be a first notification message as described before. The first notification message may comprise a device ID of the wireless communication device 114, a user ID of the user of the wireless communication device 114 and/or a time and a date at which the authentication process was executed by the authenticating circuit 212. In one embodiment of the present invention, the first notification message may also include information related to the battery 206. At step 314, if the replaced battery used in the wireless communication device 114 is an authentic battery, the network server 102 is not notified at step 316.

Referring to FIG. 4, there is shown an alternative operation 400 of a wireless communication device, such as device 114 shown in FIG. 1 for communicating authenticity of a battery to a network server. However, it should be understood that the operation 400 may be performed by the wireless communication devices 116, 118, 120, 122, 124 also. The operation 400 initiates at step 402, and then the wireless communication device 114 powers ON at step 404. After powering ON the wireless communication device 114 detects whether a replaced battery is used or not at step 406.

Upon detecting that the battery 206 is a replaced battery, an authentication process is executed at step 410. If the battery 206 is not a replaced battery, no authentication process is executed at step 408 and the wireless communication device 114 functions normally. After step 410, the wireless communication device 114 then checks whether the replaced battery is an authentic battery or not at step 412. If the replaced battery is an authentic battery then no notification is sent to a network server at step 414.

After detecting that the replaced battery used is not an authentic battery, the wireless communication device 114 establishes a communication link with a wireless network at step 416. The wireless communication device 114 then notifies the network server at step 418 by sending a notification message at step 420.

In one embodiment of the present invention, the wireless communication device 114 continues to function normally regardless of the replaced battery being authenticated or not. The user of the wireless communication device 114 continues to operate any feature and/or application of the wireless communication device 114, while the wireless communication device 114 sends the first notification message regarding the unauthenticated battery to the network server 102. Also when the wireless communication device 114 receives the second notification message from the network server 102, the wireless communication device 114 continues to operate without powering down and/or blocking any feature and/or application.

While the preferred embodiments of the invention have been illustrated and described, it is to be understood that the invention is not so limited. Numerous modifications, changes, variations, substitutions and equivalents will occur to those skilled in the art without departing from the scope and spirit of the present inventions defined by the appended claims.

What is claimed is:

1. A method for communicating authenticity of a battery used in a wireless communication device, comprising:
executing an authentication process on the wireless communication device to determine authenticity of the battery used in the wireless communication device;
establishing a communication link with a wireless network; and
notifying a network server if the battery is not authenticated while allowing the wireless communication device to function, thereby causing the network server to perform a specific task in response to a notification received.

2. The method of claim 1, wherein executing the authentication process occurs in response to detecting a replaced battery.

3. The method of claim 2, wherein executing the authentication process further comprises communicating with the replaced battery.

4. The method of claim 3, wherein communicating with the replaced battery further comprises reading authenticity details of the replaced battery stored in a memory of the replaced battery.

5. The method of claim 1, wherein notifying the network server further comprises transmitting a first notification message, wherein the first notification comprises a user ID associated with the wireless communication device, and a time and a date at which the authentication process was executed at the wireless communication device.

6. The method of claim 1, further comprising receiving a second notification message from the network server if the battery is not authenticated.

7. The method of claim 6, wherein the second notification message comprises a mail to the device, a phone call to the device or an alert on a display of the wireless communication device.

8. The method of claim 1, wherein the specific task performed by the network server further comprises maintaining a database of the notification received.

9. A portable communication device comprising:
a battery having a memory configured to store authenticity details;
an authenticating circuit configured to check authenticity of the battery; and
a transceiver configured to transmit a first notification message to a network server in the event of the portable communication device not authenticating the battery, wherein the portable communication device continues to function regardless of the authenticity of the battery.

10. The portable communication device of claim 9, wherein the authenticity details include information related to battery manufacturer, date of manufacturing or battery id.

11. The portable communication device of claim 9, further comprising a reader coupled to the portable communication device for reading authenticity details stored in the memory of the battery.

12. The portable communication device of claim 9, wherein the transceiver is further configured for receiving a second notification message from the network server.

13. The portable communication device of claim 12, wherein the second notification message is a mail to the portable communication device, a phone call to the portable communication device or an alert on a display of the portable communication device.

14. The portable communication device of claim 9, wherein the first notification message comprises a user ID associated with the portable communication device, and a time and a date at which the authentication process is executed at the portable communication device.

15. The portable communication device of claim 9, wherein the portable communication device is a wireless communication device, a personal digital assistant or a hand held computer.
